(19) United States
(12) Patent Application Publication
(10) Pub. No.: US 2024/0353269 A1
(43) Pub. Date: Oct. 24, 2024

(54) SYSTEM FOR MEASURING AT LEAST ONE THERMAL MAGNITUDE DESIGNED TO LIMIT THE IMPACT OF CONVECTIVE HEAT TRANSFERS, AIRCRAFT PROPULSION ASSEMBLY INCLUDING AT LEAST ONE SUCH SYSTEM

(71) Applicant: Airbus Operations SAS, TOULOUSE (FR)

(72) Inventor: Christian FLEMIN, TOULOUSE (FR)

(21) Appl. No.: 18/637,736

(22) Filed: Apr. 17, 2024

(30) Foreign Application Priority Data
Apr. 20, 2023 (FR) 2303946

(51) Int. Cl. G01K 13/024; F01D 17/08

(52) U.S. Cl. CPC G01K 13/024; F01D 17/085; F05D 2260/231; F05D 2260/80; F05D 2270/80

(57) ABSTRACT

A measurement system for measuring at least one thermal magnitude at a point of a propulsion assembly of an aircraft. The measurement system is connected to a structure integral with the propulsion assembly and comprises at least one thermal sensor as well as at least one barrier transparent to infrared radiation in at least one zone of the barrier. The barrier at least partially delimits a cavity in which the thermal sensor is positioned. Also an aircraft propulsion system with at least one such measurement system.

### CROSS-REFERENCES TO RELATED APPLICATIONS

This application claims the benefit of French Patent Application Number 2303946 filed on Apr. 20, 2023, the entire disclosure of which is incorporated herein by way of reference.

### FIELD OF THE INVENTION

The present application relates to a system for measuring at least one thermal magnitude, such as temperature or heat flux, as well as an aircraft propulsion assembly including at least one such system.

### BACKGROUND OF THE INVENTION

According to one embodiment, a propulsion assembly of an aircraft comprises a motor and a nacelle positioned about the motor and designed to channel a primary air flow in the motor and a secondary air flow between the motor and the nacelle. In operation, the motor generates very high internal radiant ambient temperatures and internal air temperatures, in the order of several hundred degrees. To operate correctly, some equipment located in the motor or the nacelle that is sensitive to high temperatures is protected by protection elements such as heat shields, thermal insulation and/or heat dissipation and cooling systems such as radiators, for example. The design of these protection elements requires the precise determination of the radiative heat fluxes liable to impact the equipment sensitive to high temperatures, the evolution of the internal radiant ambient temperature or the evolution of the air temperature in these zones where such equipment is installed in order to optimize the mass of these protection elements and the choice of materials, ensuring not to over-dimension said elements so as to limit costs and impact on the performance of the propulsion assembly of the aircraft. During operation of the aircraft, heat dissipation and cooling systems may cause aerodynamic disturbances. Consequently, during operation of the aircraft, it is important to precisely determine the radiative heat fluxes liable to impact the equipment sensitive to high temperatures, the evolution of the radiant ambient temperature or the evolution of the air temperature in the zones where such equipment is installed in order to optimize operation of these heat dissipation and cooling systems.

According to one embodiment, a thermocouple or a temperature sensor such as a thermistor is used to measure the temperature at a given point. According to another embodiment, a heat flux sensor is used to measure the radiative and/or conductive heat flux absorbed. These embodiments of simple design are not satisfactory since they do not enable the precise measurement of a thermal magnitude such as a skin temperature of a piece of equipment or a radiative heat flux absorbed at a point, notably if this point is located in an environment impacted by complex convective heat fluxes such as in a propulsion assembly.

### SUMMARY OF THE INVENTION

The present invention aims to overcome all or some of the aforementioned drawbacks.

For this purpose, the invention relates to a system for measuring at least one thermal magnitude, the measurement system being designed to be connected to a structure and comprising at least one thermal sensor.

According to the invention, the measurement system comprises at least one barrier transparent to infrared radiation in at least one zone of said barrier, the latter at least partially delimiting a cavity in which the thermal sensor is positioned and that has a shape factor equal to or greater than 0.8.

This solution filters the heat fluxes, notably unwanted conductive heat fluxes, impacting the thermal sensor and protects it at least against convective heat fluxes. This makes it possible to precisely determine the temperature at a given point in a propulsion assembly of an aircraft or the radiative heat flux impacting that point.

According to another feature, the cavity contains a controlled atmosphere having at least one of the following features: high vacuum, high degree of filling with inert gas, low humidity, and low contaminant content.

According to another feature, the barrier has a transmittance equal to or greater than 80% for rays having a wavelength of between 0.7 μm and 12 μm.

According to another feature, the thickness of the barrier is equal to or less than 1 mm.

According to another feature, the measurement system comprises a support that extends between the first and second ends, the thermal sensor being fastened to the first end. Additionally, the barrier comprises an orifice designed to enable the support to pass therethrough, the measurement system comprising at least one sealing system connecting the support and barrier at the orifice.

According to another feature, the thermal sensor is arranged beside the structure and connected to the latter by at least one element with high thermal conductivity.

According to another feature, the barrier forms a shell that has a periphery connected sealingly to the structure so as to delimit the cavity in which the thermal sensor is positioned.

According to another feature, the shell comprises at least one layer made of a porous or nano-porous material that is transparent to infrared radiation.

According to another feature, the barrier forms a closed envelope surrounding the thermal sensor and delimiting the cavity in which the thermal sensor is positioned.

According to another feature, the thermal sensor is remote from the structure and insulated from the latter in terms of conductive heat flux.

According to another feature, the closed envelope comprises at least a first portion that has an inner face oriented towards the thermal sensor positioned in the closed envelope and an outer face oriented towards the structure. Additionally, the measurement system comprises a first interface connecting the thermal sensor and the inner face, as well as a second interface connecting the structure and the outer face, the first and second interfaces having a high conductivity, the first portion of the closed envelope being made of a material having a high thermal conductivity.

According to another feature, the first portion of the closed envelope is designed to be opaque to infrared radiation and to have an emissivity for infrared radiation close or equal to that of the material of the structure.

The invention also relates to an aircraft propulsion assembly including at least one measurement system for measuring at least one thermal magnitude according to one of the preceding features.

### BRIEF DESCRIPTION OF THE DRAWINGS

Other features and advantages are set out in the description of the invention below, given purely by way of example and with reference to the attached drawings, in which:

FIG. 1 is a longitudinal cross section of a portion of a propulsion assembly,

FIG. 2 is a schematic representation of a system for measuring at least one thermal magnitude illustrating one embodiment of the invention,

FIG. 3 is a schematic representation of a system for measuring at least one thermal magnitude illustrating another embodiment of the invention,

FIG. 4 is a schematic representation of a system for measuring at least one thermal magnitude illustrating another embodiment of the invention, and

FIG. 5 is a schematic representation of a system for measuring at least one thermal magnitude illustrating another embodiment of the invention.

### DETAILED DESCRIPTION OF THE PREFERRED EMBODIMENTS

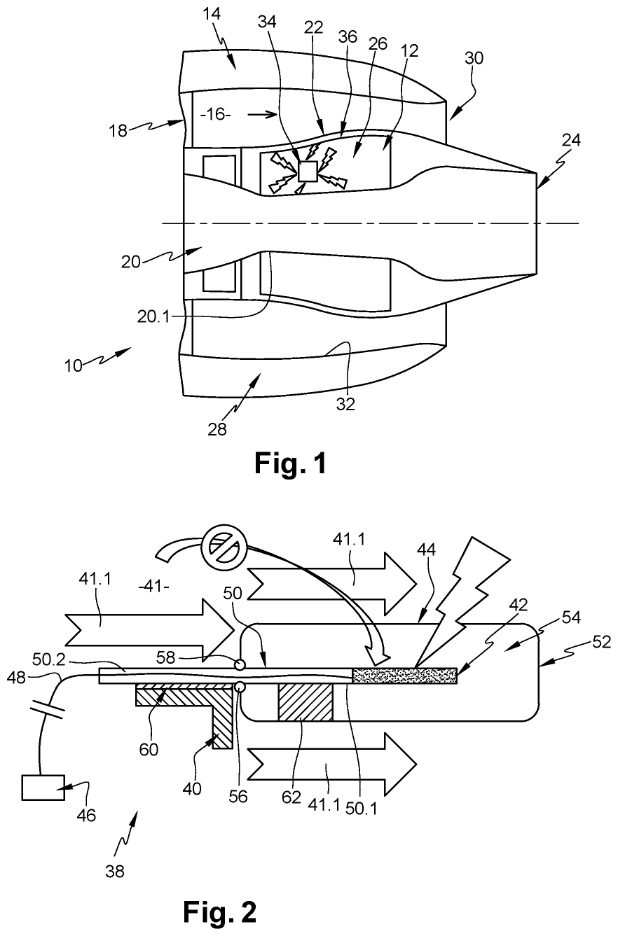

According to one embodiment shown in FIG. 1, an aircraft comprises at least one propulsion assembly 10 including a motor 12, a nacelle 14 positioned about the motor 12, as well as an annular duct 16 located between the motor 12 and the nacelle 14.

The motor 12 comprises, from front to back, a fan 18, a motor core 20 delimited by an envelope 20.1, an outer wall 22 surrounding the motor core 20, remote from the envelope 20.1 thereof, as well as a first nozzle 24 extending the motor core 20. The outer wall 22 is also referred to as the inner fixed structure (IFS). The motor 12 comprises an intermediate zone 26 (also referred to as the core zone) positioned between the envelope 20.1 of the motor core 20 and the outer wall 22.

The nacelle 14 comprises an air inlet upstream of the motor 12, an intermediate portion intended to surround the fan, a rear portion 28 that may incorporate thrust reversal means, positioned about the outer wall 22 and usually terminated by a second nozzle 30. The nacelle 14 also has an inner wall 32 (also referred to as the inner fixed structure) spaced apart from the motor 12, notably from the outer wall 22 thereof.

When in operation, a primary flow circulates in the motor core 20 and is discharged via the first nozzle 24. A secondary flow coming from the fan 18 circulates in the annular duct 16 delimited by the outer wall 22 of the motor 12 and the inner wall 32 of the nacelle 14. The primary and secondary flows are discharged by the first and second nozzles 24, 30. The outer wall 22 of the motor 12 separates a hot zone inside the motor 12, in the intermediate zone 26, and a cold zone outside the motor 12, in the annular duct 16. According to one arrangement, the propulsion assembly 10 comprises at least one piece of equipment 34 positioned in this intermediate zone 26.

According to one embodiment, the propulsion assembly 10 comprises at least one thermal protection element 36, such as a convective cooling system, designed to ventilate the intermediate zone 26 and to send cold air from the cold zone to the hot zone and/or a heat shield to limit the impact of radiative heat transfers on the equipment 34. This heat shield may be fastened directly to the equipment 34 or to the envelope 20.1 of the motor core 20. It may be positioned in different zones of the propulsion assembly 10.

The propulsion assembly 10, the motor 12 and the nacelle 14 are not described further since they may be identical to those of the prior art. Regardless of the embodiment, the propulsion assembly 10 comprises at least one piece of equipment 34 that is sensitive to high temperatures, as well as at least one thermal protection element 36.

As illustrated in FIGS. 2 to 5, the propulsion assembly 10 comprises at least one measurement system 38 for measuring at least one thermal magnitude, said thermal magnitude notably being a temperature or a radiative heat flux. This measurement system 38 is connected to a structure 40 integral with the propulsion assembly 10 and positioned in an environment 41, notably a convective environment, having an air flow 41.1 indicated by arrows. This air flow 41.1 can convey at least one complex convective heat flux in three dimensions. “Structure 40” means a structure, the skin of a structure, a piece of equipment or any other element of the propulsion assembly 10.

This measurement system 38 comprises at least one thermal sensor 42 designed to determine at least one thermal magnitude, as well as at least one barrier 44 transparent to infrared radiation in at least one zone of said barrier 44, said barrier 44 being designed to insulate the thermal sensor 42 from the air flow 41.1. This barrier 44 protects the thermal sensor 42 from any contaminants and/or from convective heat fluxes carried notably by the air flow 41.1 and limits the impact of the latter on the measurement of each magnitude by the thermal sensor 42.

According to one layout, the thermal sensor 42 is a thermocouple, a thermistor, or a heat flux sensor. According to one embodiment, the thermal sensor 42 is designed to convert a first physical magnitude, such as temperature or a heat flux, into a second physical magnitude, such as an electric current. The measurement system 38 comprises at least one analysis system 46, such as a controller or computer, remote from the thermal sensor 42, as well as at least one electric cable 48 connecting the thermal sensor 42 and the analysis system 46.

For the present application, infrared rays have wavelengths between 0.7 μm and 12 μm.

According to one embodiment, the barrier 44 is made of a material designed to transmit at least 80% of infrared rays. The material of the barrier 44 has a low thermal conductivity, equal to or less than 1.5 W/m·K. According to one layout, the transmittance (or coefficient of transmission) of the barrier 44 is as high as possible, equal to or greater than 80%, preferably equal to or greater than 90% and as close as possible to 100%, for rays having a wavelength between 0.7 μm and 12 μm corresponding to infrared radiation.

The material of the barrier 44 is selected from the following materials: a transparent glass ceramic such as SrᵢAlⱼSₖO₈, CaF₂, AlON, GaᵢGeⱼSₖ TeᵢNbⱼBᵢₖ, KBr, BaO—GeO₂—Ga₂O₃, a polycarbonate, Teᵢ—Asⱼ—Geₖ, CaLa₂S₄, BK7 glass, Q2 quartz, zinc selenide, etc. This list is not exhaustive.

According to one layout, the thickness of the barrier 44 is equal to or less than 1 mm.

According to one embodiment shown in FIGS. 2 to 5, the measurement system 38 comprises at least one sheath 50 that extends between the first and second ends 50.1, 50.2, the thermal sensor 42 being fastened to the first end 50.1, the sheath 50 passing through the barrier 44. This sheath 50 is more or less rigid. Where it is rigid, it may provide the support function designed to support the thermal sensor 42 and the barrier 44. Each electric cable 48 runs through the sheath 50. The latter is usually electrically insulated.

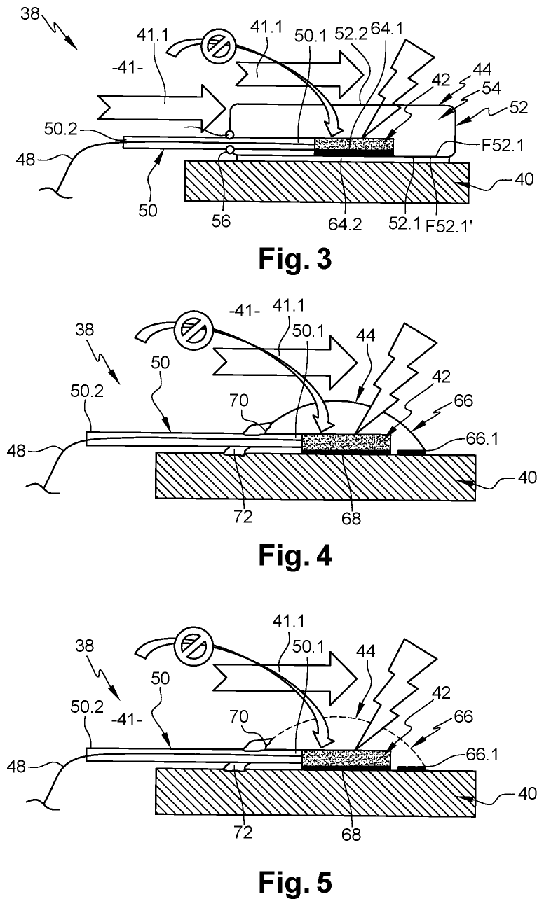

According to the embodiments shown in FIGS. 2 and 3, the barrier 44 forms a closed envelope 52 surrounding the thermal sensor 42, delimiting a cavity 54 in which the thermal sensor 42 is positioned. According to one arrangement, the closed envelope 52 is cylindrical. Of course, the invention is not limited to this geometric shape.

According to one layout, the cavity 54 is vacuumized or contains an inert gas. According to one layout, the barrier 44 formed by the closed envelope 52 comprises an orifice 56 designed to enable the sheath 50 to pass therethrough. Additionally, the measurement system 38 comprises at least one sealing system 58 connecting the sheath 50 and the barrier 44 at the orifice 56 so as to sealingly close the cavity 54.

According to one embodiment shown in FIG. 2, the closed envelope 52 is remote from the structure 40. According to this embodiment, the sheath 50 performs the support function and the second end 50.2 thereof is connected to the structure 40. For this purpose, the measurement system 38 comprises at least one joining element 60 connecting the sheath 50 and the structure 40, such as glue, putty, at least one rivet, at least one bolt, at least one screw or other.

According to one arrangement, the structure 40, the sheath 50 and/or the joining element 60 are made of a material having low thermal conductivity. This solution makes it possible to filter the heat fluxes by preventing passage of the conductive heat fluxes between the structure 40 and the thermal sensor 42.

According to one embodiment, the measurement system 38 comprises a joining element 62 made of a material having low thermal conductivity to connect the closed envelope 52 on one hand and the sheath 50 and/or the thermal sensor 42 on the other hand. This solution makes it possible to filter the heat fluxes by insulating the thermal sensor 42 from the conductive heat fluxes through the wires 48 and the sheath 50.

According to the embodiment shown in FIG. 2, the closed envelope 52 is made entirely of a material transparent to infrared radiation. This closed envelope 52 makes it possible to filter the heat fluxes by only permitting passage of the radiative heat fluxes and by insulating the thermal sensor 42 from the convective heat fluxes. Since the thermal sensor 42 is insulated in terms of thermal conduction from the closed envelope 52, it is not impacted by the conductive heat fluxes.

According to another embodiment shown in FIG. 3, the closed envelope 52 comprises at least a first portion 52.1 that has an inner face F52.1 oriented towards the thermal sensor 42 positioned in the closed envelope 52 and an outer face F52.1′ oriented towards the structure 40. The first portion 52.1 is shaped like the structure 40 so as to fit the shapes thereof and to be pressed closely against said structure 40. Thus, the first portion 52.1 of the closed envelope 52 is interposed between the structure 40 and the thermal sensor 42.

According to the embodiment shown in FIG. 3, the closed envelope 52 is in contact with the structure 40. The measurement system 38 comprises a first interface 64.1 connecting the thermal sensor 42 and the inner face F52.1 as well as a second interface 64.2 connecting the structure 40 and the outer face F52.1′, the first and second interfaces 64.1, 64.2 having a high conductivity so as not to filter the conductive heat fluxes between the structure 40 and the thermal sensor 42.

According to one arrangement, the thickness of the first and second interfaces 64.1, 64.2 is equal to or less than 0.2 mm. As an example, the first and second interfaces 64.1, 64.2 are obtained by gluing using a glue having a relatively high thermal conductivity that is equal to or greater than 0.2 W/m·K. Of course, the invention is not restricted to this embodiment for the first and second interfaces 64.1, 64.2.

According to a first layout, unlike the embodiment shown in FIG. 2, the closed envelope 52 is not made of a single material transparent to infrared radiation. The portion 52.1 is made of a first material having a high thermal conductivity, while the remainder of the closed envelope 52, referred to as the second portion 52.2, is made of a material that is transparent to infrared radiation and has a low thermal conductivity. According to a variant, the first portion 52.1 is made of a material opaque to infrared radiation having an emissivity for infrared radiation close or equal to that of the material of the structure 40. Where the measurement system 38 may be impacted by solar rays, the second portion 52.2 may be made of a material filtering the solar rays but allowing infrared radiation to pass.

According to a second layout, the closed envelope 52 is made entirely of a material transparent to infrared radiation and at least one of either the inner face F52.1 or the outer face F52.1′ of the portion 52.1 is covered with a coating opaque to infrared radiation, said coating being made of a material having an emissivity for infrared radiation close or equal to that of the material of the structure 40. According to the first and second layouts, the portion 52.1 of the closed envelope 52 is designed to be opaque to infrared radiation and to have an emissivity for infrared radiation close or equal to that of the material of the structure 40.

The embodiment shown in FIG. 3 reduces the temperature gradient between the structure 40 and the thermal sensor 42. It is more specifically suited to measuring the temperature of a surface zone of the structure 40 positioned at the thermal sensor 42 or to measuring a heat flux exchanged by a surface zone of the structure 40 positioned at the thermal sensor 42.

According to the embodiments shown in FIGS. 2 and 3, the thermal sensor 42 connected to the sheath 50 is inserted into the closed envelope 52. According to the embodiment shown in FIG. 3, the thermal sensor 42 is connected to the closed envelope 52. Once the closed envelope 52 has been vacuumized or filled with an inert gas, the sealing system 58 is installed to sealingly close the cavity 54. Next, the sheath 50 is connected to the structure 40 according to the embodiment shown in FIG. 2 or the closed envelope 52 is connected to the structure 40 according to the embodiment shown in FIG. 3.

According to the embodiments shown in FIGS. 4 and 5, the barrier 44 forms a shell 66 that has a periphery 66.1 connected sealingly to the structure 40 so as to delimit a sealed cavity 54 in which the thermal sensor 42 is positioned. According to one arrangement, the shell 66 is a hemisphere. Of course, the invention is not limited to this shape for the shell 66.

According to one layout, the measurement system 38 comprises at least one connection 68 connecting the thermal sensor 42 and the structure 40, the barrier 44 not being interposed between the thermal sensor 42 and the structure 40. According to one arrangement, this connection 68 is thermally conductive.

According to one layout, the barrier 44 formed by the shell 66 comprises an orifice 70 designed to enable the sheath 50 to pass therethrough. Additionally, the measurement system 38 comprises at least one sealing system 72 connecting the sheath 50 and the barrier 44 at the orifice 70 so as to sealingly close the cavity 54.

According to an embodiment shown in FIG. 4, the shell 66 is made of a material transparent to infrared radiation, this material being non-porous.

According to this embodiment, once the thermal sensor 42 has been fastened to the structure 40, the shell 66 is connected to the structure 40 in a controlled atmosphere to ensure that the air trapped between the shell 66 and the structure 40 has a low humidity level and a low contaminant content at atmospheric pressure on the ground.

According to an embodiment shown in FIG. 5, the shell 66 is permeable to liquids while significantly reducing the effect of convection between the air in the zone located outside the barrier 44. This solution provides a draining barrier 44 enabling any liquids present in the cavity 54 to be discharged.

According to one layout, the shell 66 comprises a single layer made of a porous or nano-porous material that is transparent to infrared radiation. According to another layout, the shell 66 comprises a first perforated layer made of a material transparent to infrared radiation, as well as a second layer covering the first layer and made of a porous or nano-porous material transparent to infrared radiation.

As an example, the shell 66 is made of a nano-structured glass coated with SiO₂ or ITO, polycarbonate coated with AR, or a nano-porous material such as chalcogenide glass ceramic. This list is not exhaustive.

Regardless of the embodiment, the measurement system 38 for measuring at least one thermal magnitude is designed to be connected to a structure 40 and positioned in at least one convective heat flux. It comprises at least one thermal sensor 42 as well as at least one barrier 44 transparent to infrared radiation in at least one zone of said barrier 44, the barrier 44 at least partially delimiting a cavity 54 in which the thermal sensor 42 is positioned. This solution filters the heat fluxes impacting the thermal sensor 42 and protects it at least against convective heat fluxes. The thermal sensor 42 is selected from the available thermal sensors that are reliable and of simple design.

According to one layout, the cavity 54 contains a controlled atmosphere having at least one of the following features: high vacuum, high degree of filling with inert gas, low humidity, and low contaminant content.

According to a first embodiment, the thermal sensor 42 is remote from a structure 40 of the propulsion assembly 10 and insulated from the latter in terms of conductive heat fluxes. According to this first embodiment, the thermal sensor is impacted by the radiative heat fluxes and protected from the convective and conductive heat fluxes. This embodiment is more specifically suited to precisely determining the impact of the radiative heat fluxes at a given point of the propulsion assembly 10 remote from the structure 40, by limiting the disturbances related to any contaminants and/or convective and conductive heat fluxes.

According to other embodiments, the thermal sensor 42 is arranged beside a structure 40 of a propulsion assembly 10 and connected to the latter by at least one element having high thermal conductivity, limiting the appearance of a thermal gradient between the thermal sensor 42 and the structure 40. This embodiment is more specifically suited to precisely determining the temperature or the heat flux exchanged at a given point on the surface of the structure 40, at which the thermal sensor 42 is positioned, by limiting the disturbances related to any contaminants and/or convective heat fluxes.

Of course, the invention is not limited to the embodiments described above. The barrier 44 may have a different shape (other than cylindrical or hemispherical). Regardless of the embodiment and unlike the measurement systems in the prior art that comprise a barrier in the form of a porthole limiting the directions of the radiation impacting the thermal sensor 42, the barrier 44 has a shape factor equal to or greater than 0.8. Thus, the thermal sensor 42 can receive radiation from a multitude of directions and over a larger solid angle than in the solutions in the prior art.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A measurement system for measuring at least one thermal magnitude, the measurement system configured to be connected to a structure and comprising:
at least one thermal sensor, and
at least one barrier, the at least one barrier transparent to infrared radiation in at least one zone of the at least one barrier, the at least one barrier at least partially delimiting a cavity in which the at least one thermal sensor is positioned, and wherein the at least one barrier has a shape factor equal to or greater than 0.8.

2. The measurement system of claim 1, wherein the cavity contains a controlled atmosphere having one or more of the following features: high vacuum, high degree of filling with inert gas, low humidity, and low contaminant content.

3. The measurement system of claim 1, wherein the at least one barrier has a transmittance equal to or greater than 80% for rays having a wavelength of between 0.7 μm and 12 μm.

4. The measurement system of claim 1, wherein a thickness of the at least one barrier is equal to or less than 1 mm.

5. The measurement system of claim 1, further comprising:
a sheath extending between first and second ends, the at least one thermal sensor fastened to the first end,
wherein the at least one barrier comprises an orifice configured to enable the sheath to pass therethrough, and
wherein in that the measurement system comprises at least one sealing system connecting the sheath and the at least one barrier at the orifice.

6. The measurement system of claim 1, wherein the at least one thermal sensor is arranged beside the structure and connected to the structure by at least one element with high thermal conductivity.

7. The measurement system of claim 6, wherein the at least one barrier forms a shell that has a periphery connected sealingly to the structure so as to delimit the cavity in which the at least one thermal sensor is positioned.

8. The measurement system of claim 7, wherein the shell comprises at least one layer made of a porous or nano-porous material that is transparent to infrared radiation.

9. The measurement system of claim 1, wherein the at least one barrier forms a closed envelope surrounding the at least one thermal sensor and delimiting the cavity in which the at least one thermal sensor is positioned.

10. The measurement system of claim 9, wherein the at least one thermal sensor is remote from the structure and insulated from the structure in terms of conductive heat flux.

11. The measurement system of claim 9, wherein the closed envelope comprises at least a first portion having an inner face oriented towards the at least one thermal sensor positioned in the closed envelope and an outer face oriented towards the structure,
wherein the measurement system comprises a first interface connecting the at least one thermal sensor and the inner face and comprises a second interface connecting the structure and the outer face, the first and second interfaces having a high conductivity, and
wherein the first portion of the closed envelope is made of a material having a high thermal conductivity.

12. The measurement system of claim 11, wherein the first portion of the closed envelope is opaque to infrared radiation and has an emissivity for infrared radiation close or equal to that of a material of the structure.

13. An aircraft propulsion assembly comprising:
the measurement system of claim 1.
